(19) United States
(12) Patent Application Publication
(10) Pub. No.: US 2017/0315849 A1
(43) Pub. Date: Nov. 2, 2017

(54) APPLICATION TARGET EVENT SYNTHESIS

(71) Applicant: Microsoft Technology Licensing, LLC, Redmond, WA (US)

(72) Inventors: Peter G. Salas, Seattle, WA (US); Bogdan Brinza, Seattle, WA (US); Rossen Atanassov, Bellevue, WA (US)

(73) Assignee: Microsoft Technology Licensing, LLC, Redmond, WA (US)

(21) Appl. No.: 15/402,971

(22) Filed: Jan. 10, 2017

Related U.S. Application Data
(60) Provisional application No. 62/329,886, filed on Apr. 29, 2016.

(51) Int. Cl. G06F 9/54; G06F 9/44; G06F 3/16

(52) U.S. Cl. CPC G06F 9/542; G06F 9/4443; G06F 3/167

(57) ABSTRACT

Examples are disclosed that relate to event synthesis for application targets. One example provides a computing system including a logic machine and a storage machine holding instructions executable by the logic machine to, receive, via an accessibility tool, a user input of an invoke command, identify an application target for which the invoke command is intended, the target presented in a presentation framework, based at least in part on the application target, determine an event for the application target that is congruent with the application target and the invoke command, and synthesize the event. The instructions may be further executable to apply the event to the application target.

### CROSS REFERENCE TO RELATED APPLICATIONS

This application claims priority to U.S. Provisional Patent Application No. 62/329,886, filed Apr. 29, 2016, the entirety of which is hereby incorporated herein by reference.

### BACKGROUND

A variety of accessibility tools have been developed to facilitate interacting with a computing device, particularly to account for disabilities or impairment. For example, an accessibility tool may enable a user to supplant keyboard and/or mouse input with voice input, or may employ a voice synthesizer to describe/narrate displayed text and graphical content. To enable an accessibility tool to mediate interaction with an application, an accessibility framework may establish a standardized format in which application information can be interpreted by the accessibility tool. As such, compatibility of the application with the accessibility framework may be required—e.g., application support for interfaces and patterns stipulated by the framework.

### BRIEF DESCRIPTION OF THE DRAWINGS

FIG. 1 schematically shows an example system for enabling the use of an accessibility tool.

FIG. 2 shows an example web application and DOM tree structure.

FIG. 3 shows a software stack in which event synthesis occurs at a web browser application layer.

FIG. 4 shows another example web application and DOM tree structure.

FIG. 5 shows a flowchart illustrating a method of determining and synthesizing an event for an application target.

FIG. 6 shows a block diagram of an example computing device.

### DETAILED DESCRIPTION

As described above, various accessibility tools have been developed to reduce the difficulty of interacting with a computing device. Many accessibility tools are designed to mitigate interaction issues associated with user disability or impairment. An interpreter, for example, may allow users to supply voice input in lieu of other, traditional inputs such as keyboard and mouse inputs, while a narrator may use a voice synthesizer to describe graphical content. To enable the use of an accessibility tool with a range of applications, an accessibility framework may establish a format in which application information can be accessed by the accessibility tool and/or in which user input can be provided to applications. The accessibility framework may define interfaces and patterns so that an accessibility tool can perform its intended functions when information is exchanged in accordance with the defined interfaces and patterns.

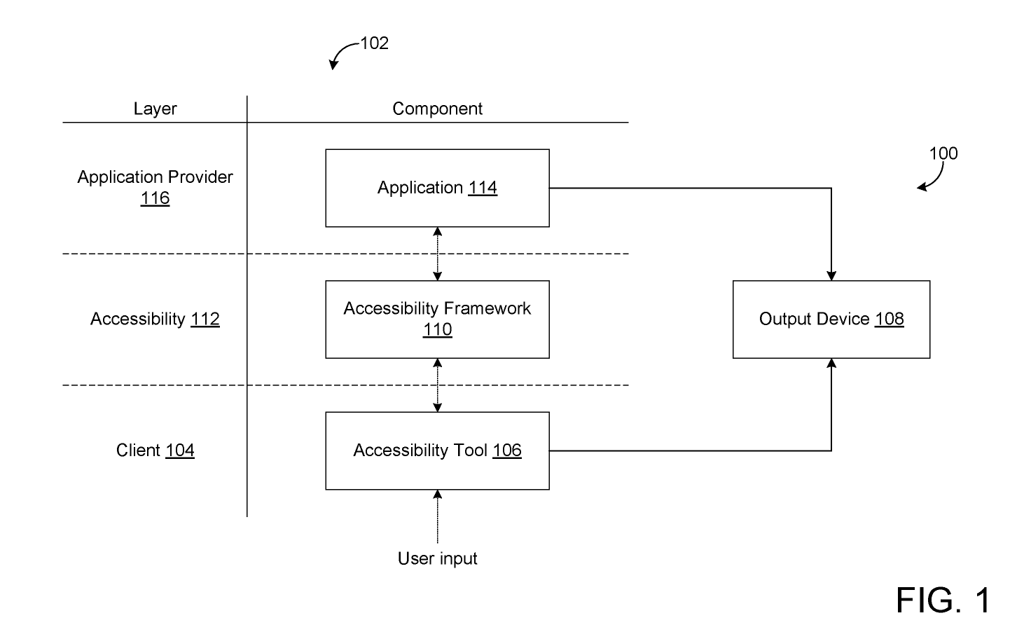

FIG. 1 schematically shows an example system 100 for enabling the use of an accessibility tool. System 100 includes a software stack 102 implementing various layers, each of which include respective components. A client layer 104 includes an accessibility tool (AT) 106 configured to mediate user interaction with a computing device and applications executed thereon. AT 106 may enable users to supplant traditional forms of input (e.g., keyboard, mouse, controller) with voice, gaze, touch, or other forms of input; receive audio descriptions of graphical content; output text to a Braille display; augment graphical content with high-contrast imagery; or may perform any other suitable function. AT 106 may receive user input, which may be passed to applications in a processed or unprocessed form as described in further detail below. Alternatively or additionally, AT 106 may provide output to an output device 108, which may be a display device, acoustic device, or any other suitable device. AT 106 may communicate in accordance with an accessibility framework (AF) 110 in an accessibility layer 112 of software stack 102.

AF 110 is configured to mediate interaction between AT 106 and applications by establishing a format in which information can be exchanged between the AT and applications. The format abstracts aspects unique or specific to AT 106 and applications so that the AT (and potentially other ATs) is made compatible with a variety of applications. In this way, configuring AT 106 to be compatible with AF 110 may enable the AT to support a large variety of applications that support the AF, rather than requiring the adaptation of the AT to each application.

In the example depicted in FIG. 1, AF 110 mediates interaction between AT 106 and an application 114 in an application provider layer 116 of software stack 102. To support AF 110 and AT 106, application 114 may be configured to provide application information in the format established by the AF. The format may stipulate interfaces, control patterns, properties, etc. For example, application 114 may include a plurality of graphical user interface (GUI) controls such as buttons, scrollbars, checkboxes, combo boxes, etc. whose types are conveyed to AT 106 in the form of a control type stipulated by AF 110. Application 114 may also expose the functionality of UI elements by providing control patterns stipulated by AF 110 to AT 106. AT 106 can then manipulate GUI controls of application 114 in accordance with the functionality exposed by the provided control patterns.

In some examples, application 114 may not support some interfaces, control patterns, or other aspects of the format established by AF 110. A particular GUI control of application 114, for example, may fail to support a specific control pattern required to enable AT 106 to interact with that GUI control. As such, a user may be unable to interact with the GUI control using AT 106. While such inability to interact may be partially mitigated by using a traditional input device (e.g., keyboard), the use of a traditional input device may not be feasible for some users and/or use contexts. For example, a computing device that employs a touch sensor as its sole or primary mechanism of receiving user input may be unable to provide a fallback via a keyboard, mouse, etc.

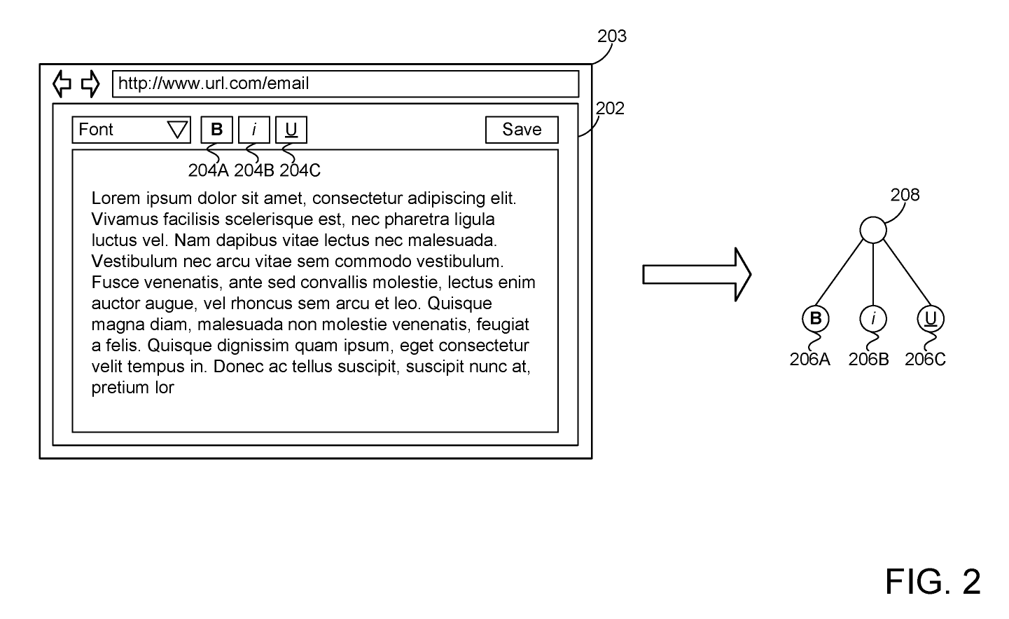

AT-application incompatibility may be a particular issue on web platforms due to the configuration of event handlers. FIG. 2 shows an example web application 202 that may be provided via a web browser application 203. Web application 202 is shown in the form of a word processing application, but may assume any suitable form and function. Web application 202 includes a plurality of GUI controls including various controls for formatting text: a bold button 204A, an italics button 204B, and an underline button 204C. Users may interact with each formatting button 204 to effect its corresponding functionality.

Different components of the web platform that enable the provision of web application 202 may handle the representation/storage of, and interaction with, the web application, respectively. Aspects of web application 202 may be represented according to a document object model (DOM), for example, and an interaction engine such as JavaScript may handle interaction with and/or changes to the DOM of web application 202. FIG. 2 shows an example tree structure in the DOM of web application 202 associated with formatting buttons 204, including respective leaf nodes 206A-C for each formatting button. In this example, a hub node 208 is a parent or ancestor node of leaf nodes 206. Leaf nodes 206 may include respective event handlers for handling interaction events with their corresponding buttons 204, while in other implementations hub node 208 may include a centralized event handler that receives events applied to the leaf nodes and propagated up to the hub node in the so-called “event bubbling” approach.

In a typical implementation, the event handler for hub node 208 handles interaction events with buttons 204, and is configured for specific types of interaction events and/or input devices. For example, a typical event handler associated with hub node 208 may stipulate an action to be executed in response to specific mouse events (mouse up/down; mouse click; pointer up/down; etc.). Similarly, typical event handlers may be configured for interaction events specific to other traditional input devices (e.g., key up/down sequences and/or simultaneous key combinations on keyboards). As such, event handlers configured in this manner may be unable to handle interaction events for which they are not configured. Consequently, these events, while being potentially bubbled up to hub or other ancestor nodes, will fail to result in a dispatch to the interaction engine and the execution of the corresponding GUI control functionality.

The configuration of event handlers for traditional input devices or specific types of interaction events may be particularly problematic for ATs. As described above, many ATs allow users to supplant traditional inputs (e.g., keyboard and/or mouse inputs) for which typical event handlers are configured with alternative inputs—e.g., voice, gaze, and touch. Typically, however, when a user intends to invoke a GUI control—e.g., activate or select the UI element—using such alternative inputs, this interaction event is interpreted and issued to the event handler associated with the GUI control as an invoke command. This invoke command is a generic interaction event not equivalent to the specific interaction events described above for which event handlers may be configured (e.g., mouse up/down, mouse click, pointer up/down). As such. ATs may not be able to interact with GUI controls and/or other application targets (e.g., elements for which a corresponding GUI control is not provided) using generic invoke commands. The applicability of ATs may thus be largely restricted in web contexts due to the widespread specific configuration of event handlers described above. Moreover, the inability to interpret invoke commands may be accompanied by a loss of granularity. Specifically, while the variety of traditional interaction events may each be mapped to different commands (e.g., select, scroll, move, toggle, resize) to provide versatile GUI control, the single generic invoke command can at best be mapped to a single command.

Event bubbling itself may impede AT interaction with applications in web contexts. Specifically, while event bubbling may be a widespread interaction paradigm among web applications (e.g., to provide a centralized and simplified mechanism of handling interaction with multiple controls that may be interdependent), many ATs may implement a user interface automation policy that an invoke command fails if there is no event handler directly associated with the application target for which the invoke command is intended. Thus, invoke commands issued to an application target in this manner may fail if the target is represented by a DOM node lacking an event handler (e.g., a node merely implementing a transport handler without application logic), and ancestor nodes (e.g., hub node 208) may be invisible to the AT that issued the invoke commands.

In view of the above, implementations are described herein for synthesizing events for an application target that are congruent with the target and an invoke command. An event may be synthesized such that an event handler associated with the application target correctly interprets the event, causing execution of functionality associated with the target that was intended by the invoke command.

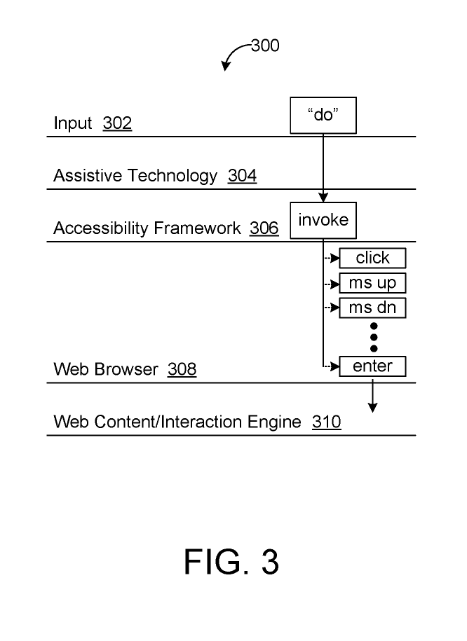

One implementation provides a web browser application configured to determine and synthesize events for application targets presented in a web-based presentation framework (e.g., HTML, Javascript). To this end, FIG. 3 shows a software stack 300 in which event synthesis occurs at a web browser application layer. In the depicted example, a user input of an invoke command is received at an input layer 302, where the user input assumes the form of a voice input including a spoken command “do.” The command may be issued to invoke a web-based application target such as a GUI control (e.g., bold button 204A of FIG. 2). Any suitable user input may be received, however, including eye gaze input, which may comprise specific gaze timings or patterns, and/or touch input, which may comprise specific touch patterns, gestures, pressures, etc.

The user input of the invoke command is then received by an AT at an AT layer 304. The AT may be an interpreter configured to interpret the spoken command “do” and output an invoke command based on the spoken command, for example. In particular, the AT outputs the invoke command in a format established by an AF at an AF layer 306. The invoke command is then provided to the web browser application at a web browser application layer 308, where a more specific event is synthesized that is congruent with the application target and invoke command—e.g., an event for which an event handler associated with the target is configured to interpret, and that corresponds to the intent of the invoke command and the user input that produced it.

FIG. 3 illustrates several example events that may be synthesized at web browser application layer 308 based on the invoke command. In particular, the example events are device-specific events for which traditional event handlers may be configured: mouse events such as mouse click, mouse up, and mouse down; and a keyboard “enter” key press event. The web browser application may synthesize any suitable events, however, which may depend on the application target and the invoke command, as described in further detail below.

The synthesized event is then passed to web content or an interaction engine (e.g., Java) at a content/engine layer 310 to be applied by the web browser to the application target. Being an event for which the event handler associated with the application target is configured to interpret, the event may successfully invoke the target and effect its corresponding functionality. In this way, the application target can be invoked without its specific adaptation to the AT and in a manner similar to scenarios in which a typical input device is used to invoke the target. Further, the synthesized event may enable invocation of the application target whether the event is interpreted by an event handler at a node directly associated with the target or is bubbled up to an event handler at an ancestor node.

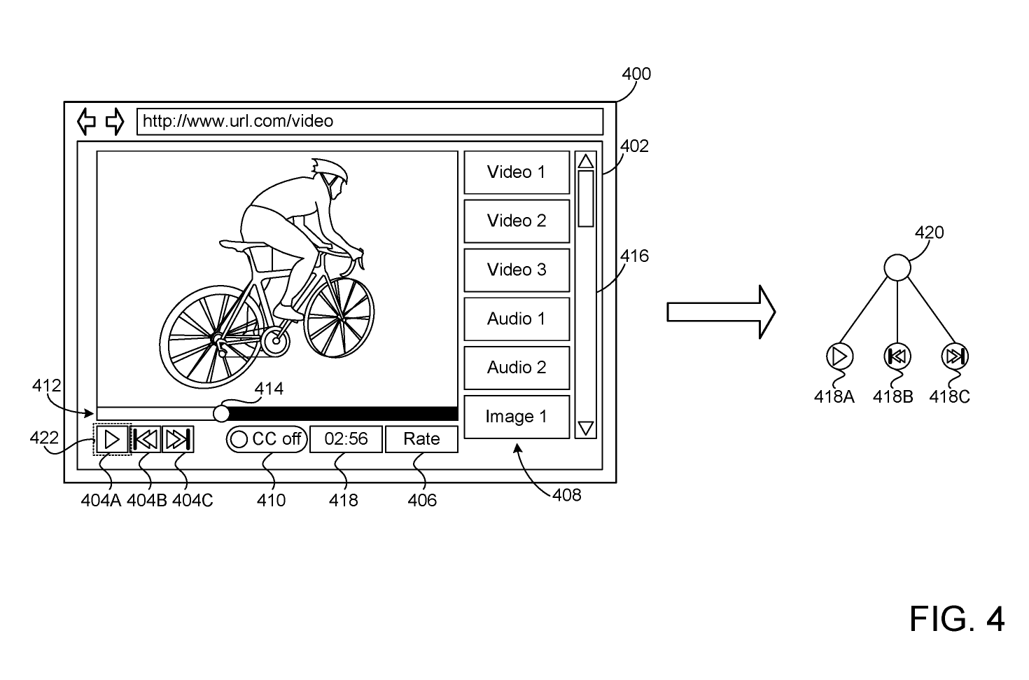

FIG. 4 shows an example web browser application 400 configured to synthesize events according to the approaches described herein. In the depicted example, web browser application 400 hosts a multimedia application 402 configured to facilitate user consumption of multimedia (e.g., video, audio, images), though the web browser application may host any suitable web application. Multimedia application 402 includes a plurality of GUI controls of which are multiple control types: various buttons, including buttons 404A-C operable to control playback of a selected video, a button 406 operable to provide user feedback regarding the selected video, and buttons 408 operable to select respective multimedia items; a toggle 410 operable to activate/deactivate closed captioning; range controls such as a progress bar 412 including a slider 414 slidingly operable to position playback of a video or audio item at a desired timestamp; a scrollbar 416 operable to preview multimedia items other than the selected item; and an input control 418 operable to display the current timestamp and receive numerical user input positioning playback of a video or audio item at a desired timestamp.

Web browser application 400 may determine and synthesize different events for different control types. Continuing with the example described above, for a button control type (e.g., for buttons 404, 406, and/or 408), mouse events such as mouse click, mouse up, and/or mouse down may be determined; for a toggle control type (e.g., for toggle 410), mouse events such as mouse click, mouse up, and/or mouse down, and/or keyboard events such as an “enter” key press event, may be determined; for a range control type (e.g., for progress bar 412 and/or slider 414), mouse events such as mouse click, mouse up, mouse down, and/or a sequence of a mouse down, cursor drag (e.g., from the current position of slider 414 to a new position within progress bar 412), and mouse up, and/or keyboard events such as a “left arrow” or “right arrow” key press, may be determined; for a scrollbar control type (e.g., for scrollbar 416), mouse events such as mouse wheel up, mouse wheel down, and/or mouse click, and/or keyboard events such as an “up arrow” or “down arrow” key press, may be determined; and for an input control type (e.g., for input control 418), keyboard events such as one or more number key presses may be determined (e.g., according to numbers specified in a user input).

Web browser application 400 may determine an event for an application target by extracting an event trigger from an event handler associated with the application target. As an example, an event handler associated with a control such as button 404A may include instructions embedded in a markup language (e.g., HTML) that specify an event trigger, which, when triggered, cause execution of the instructions. For a button control type, an event trigger may include an “onclick” trigger that causes execution of instructions in response to a mouse event such as a mouse click event. This event trigger may be extracted from its corresponding event handler, and a commensurate event such as a mouse click event may be determined and synthesized for application to the event handler. As another example, event triggers for a scrollbar control type may include “onmousewheelup” and “onmousehweeldown” triggers, which may be extracted from a corresponding event handler and used to synthesize respective mouse events, such as a mousewheel up event and a mousewheel down event.

As described above, a synthesized event may be configured for an event handler associated with an application target for which the event is synthesized. To illustrate various potential associations between an event handler and an application target, FIG. 4 shows a tree structure in the DOM of multimedia application 402 associated with buttons 404A-C, with leaf nodes 418A-C respectively representing each button 404A-C. In some examples, an event handler may be directly associated with button 404A such that the event handler is grouped with leaf node 418A, which represents button 404A. As such, a synthesized event may be applied to leaf node 418A (e.g., without bubbling the event upwards to any ancestor nodes). In another example, the event handler associated with button 404A may be grouped with an ancestor node such as a hub node 420 higher than leaf node 418A. Synthesizing an event for button 404A thus may include causing the event to bubble up from leaf node 418A to hub node 420 when applied to the leaf node 418A. In this example, the event handler grouped with hub node 420 may be associated with one or more other application targets other than button 404A, such as buttons 404B and 404C. Hub node 420 thus may act as a grouping control for centralizing interaction with buttons 404A-C, and as such may not be directly associated with a visible GUI control in multimedia application 402. However, by synthesizing events as described herein, web browser application 400 is operable to effect execution of instructions associated with hub node 420, despite its lack of direct visibility to the web browser application and users thereof.

As another example of event bubbling, multimedia application 402 may stipulate that button 406 is to be invoked before consumption (e.g., playback, display) of a multimedia item can commence. This stipulation may be implemented in markup language whereby a <div> element overrides an onclick event handler associated with button 404A to prevent its invocation before the invocation of button 406. The <div> element may be grouped with a node that is an ancestor to leaf node 418A representing button 404A. By synthesizing and bubbling up events as described herein, an appropriate event can be supplied to the <div> element associated with button 406 to enable invocation of button 404A and multimedia consumption, even if the event is initially applied to leaf node 418A and the event handler grouped therewith. More generally, synthesized events may be bubbled up a tree structure to progressively higher event handlers—e.g., from an event handler associated with a <div> element to an event handler associated with a <body> element, and so on.

Web browser application 400 may identify an application target for event synthesis, and may apply a synthesized event within a bounding geometry associated with the target. Web browser application 400 may identify application targets in any suitable manner, which may depend on the type of user input with which an invoke command is supplied. As examples, voice input may identify an application target by name and/or location (e.g., in display-space), touch input may identify an application target by location (e.g., relative to a touch sensor), and gaze input may identify an application target at the point where a projected gaze direction intersects the GUI presented by web browser application 400.

To determine a bounding geometry in which to apply a synthesized event for an identified application target, web browser application 400 may obtain the bounding geometry for the identified application target. As an example, FIG. 4 shows an example bounding geometry for an application target in the form of a bounding box 422 whose area at least covers the displayed area of button 404A. Web browser application 400 may obtain bounding box 422 by extracting an image representing button 404A from markup language specifying the image, for example. A synthesized event may be applied within bounding box 422—e.g., at the center of the bounding box or any other suitable location. As a particular example, a mouse click event may be synthesized in response to a touch input detected at or proximate to button 404A, and applied within bounding box 422 to invoke button 404A. It will be understood, however, that bounding box 422 is provided as an example and may assume any suitable geometry and spatial extent—for example, the bounding box may possess the same area as button 404A, a greater area, or a lesser area.

Other uses of bounding geometry are contemplated. As an example, web browser application 400 may obtain bounding box 422 and supply the bounding box to an AT configured to increase the visibility of graphical content displayed in web browser application 400, such that the AT may draw a high-contrast version of button 404A over and within the bounds of bounding box 422. Other functions, including but not limited to zooming in or out of GUI controls, resizing GUI controls, and repositioning GUI controls, are possible.

Various assumptions may be made when identifying an application target for receiving synthesized events. For example, an assumption may be made that a currently selected GUI control (e.g., button 404A) is the sole application target with which interaction is desired and thus synthesized events are to be applied. In this example, it may be assumed that non-selected application targets cannot be invoked.

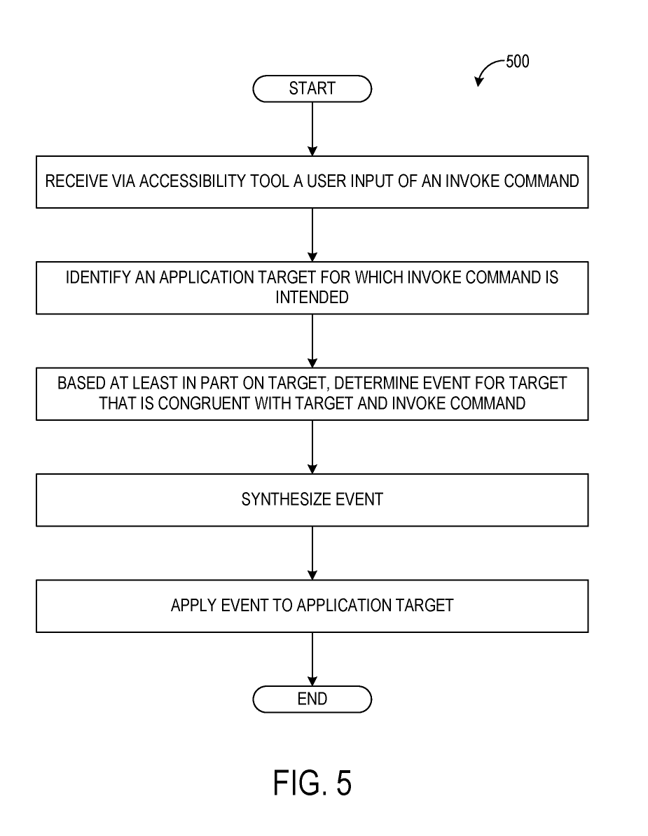

FIG. 5 shows a flowchart illustrating a method 500 of determining and synthesizing an event for an application target. Method 500 may be implemented in a web browser software module—e.g., by web browser application 400 of FIG. 4.

At 502, method 500 includes receiving, via an accessibility tool (AT), a user input of an invoke command. The user input may be a voice input of the invoke command, a touch input, a gesture input, a gaze input, or any other suitable input. The AT may be a voice interpreter or any other suitable AT.

At 504, method 500 includes identifying an application target for which the invoke command is intended, the application target presented in a presentation framework. The application target may be a GUI control, or may not be associated with a GUI control or other graphical element—e.g., the target may be embedded in a document object model (DOM). The presentation framework may be a web-based presentation framework such as HTML and/or Javascript, or may be any other suitable presentation framework. The application target may be identified in any suitable manner. For example, the application target may be identified via voice input (e.g., by name and/or location in display-space), gaze input (e.g., based on an intersection point between a projected direction of user gaze and a GUI presenting the target), and/or touch input (e.g., based on a resolved touch location as detected by a touch sensor).

At 506, method 500 includes, based at least in part on the target, determining an event for the application target that is congruent with the application target and the invoke command. The event may be configured for an event handler associated with the application target, where the association may be direct or indirect. For example, the event handler may be grouped with a node in a tree structure of a DOM, where the node represents the application target. In another example, the application target may be represented by a first node in a tree structure of a DOM, and the event handler may be grouped with a second node in the tree structure, where the second node being higher than the first node in the tree structure. The event handler may be associated with one or more application targets other than the target for which the event is determined. Determining the event may include extracting an event trigger from the event handler. One or more events commensurate with the extracted event trigger may be determined (e.g., mouse event(s) for an onclick event trigger, keyboard event(s) for a keyboard event trigger).

At 508, method 500 includes synthesizing the event. In the example tree structure described above, synthesizing the event may include causing the event to bubble up from the first node to the second node.

At 510, method 500 includes applying the event to the application target. Applying the event to the application target may include obtaining a bounding geometry associated with the application target, and applying the event at a location (e.g., at the center) within the bounding geometry.

In some embodiments, the methods and processes described herein may be tied to a computing system of one or more computing devices. In particular, such methods and processes may be implemented as a computer-application program or service, an application-programming interface (API), a library, and/or other computer-program product.

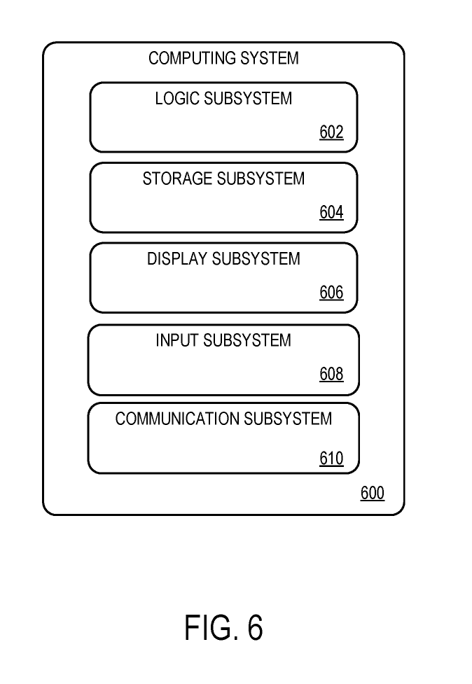

FIG. 6 schematically shows a non-limiting embodiment of a computing system 600 that can enact one or more of the methods and processes described above. Computing system 600 is shown in simplified form. Computing system 600 may take the form of one or more personal computers, server computers, tablet computers, home-entertainment computers, network computing devices, gaming devices, mobile computing devices, mobile communication devices (e.g., smart phone), and/or other computing devices.

Computing system 600 includes a logic machine 602 and a storage machine 604. Computing system 600 may optionally include a display subsystem 606, input subsystem 608, communication subsystem 610, and/or other components not shown in FIG. 6.

Logic machine 602 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 604 includes one or more physical devices configured to hold instructions executable by the logic machine to implement the methods and processes described herein. When such methods and processes are implemented, the state of storage machine 604 may be transformed—e.g., to hold different data.

Storage machine 604 may include removable and/or built-in devices. Storage machine 604 may include optical memory (e.g., CD, DVD, HD-DVD. Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 604 may include volatile, nonvolatile, dynamic, static, read/write, read-only, random-access, sequential-access, location-addressable, file-addressable, and/or content-addressable devices.

It will be appreciated that storage machine 604 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 602 and storage machine 604 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 implemented to perform a particular function. In some cases, a module, program, or engine may be instantiated via logic machine 602 executing instructions held by storage machine 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may runm on one or more server-computing devices.

When included, display subsystem 606 may be used to present a visual representation of data held by storage machine 604. This visual representation may take the form of a graphical user interface (GUI). As the herein described methods and processes change the data held by the storage machine, and thus transform the state of the storage machine, the state of display subsystem 606 may likewise be transformed to visually represent changes in the underlying data. Display subsystem 606 may include one or more display devices utilizing virtually any type of technology. Such display devices may be combined with logic machine 602 and/or storage machine 604 in a shared enclosure, or such display devices may be peripheral display devices.

When included, input subsystem 608 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 610 may be configured to communicatively couple computing system 600 with one or more other computing devices. Communication subsystem 610 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 600 to send and/or receive messages to and/or from other devices via a network such as the Internet.

Another example provides a computing device comprising a logic machine and a storage machine holding instructions executable by the logic machine to receive, via an accessibility tool, a user input of an invoke command, identify an application target for which the invoke command is intended, the target presented in a presentation framework, based at least in part on the application target, determine an event for the application target that is congruent with the application target and the invoke command, synthesize the event, and apply the event to the application target. In such an example, the instructions alternatively or additionally may be implemented by a web browser application. In such an example, the application target alternatively or additionally may be a control in a graphical user interface. In such an example, the event alternatively or additionally may be configured for an event handler associated with the application target. In such an example, the application target alternatively or additionally may be represented by a first node in a tree structure of a document object model, and the event handler alternatively or additionally may be grouped with a second node in the tree structure, the second node being higher than the first node. In such an example, the instructions executable to synthesize the event alternatively or additionally may include generating instructions that, when applied to the application target, cause the event to bubble up from the first node to the second node. In such an example, the event handler alternatively or additionally may be associated with one or more other application targets. In such an example, the instructions executable to determine the event for the application target alternatively or additionally may comprise instructions executable to extract an event trigger from the event handler. In such an example, the instructions executable to apply the event to the application target alternatively or additionally may comprise instructions executable to obtain a bounding geometry associated with the application target, and apply the event at a location within the bounding geometry. In such an example, the user input alternatively or additionally may be a voice input of the invoke command, and the accessibility tool alternatively or additionally may be a voice interpreter. In such an example, the user input alternatively or additionally may be a touch input of the invoke command, and the event alternatively or additionally may be a mouse event.

Another example provides, at a computing device, a method, comprising receiving, via an accessibility tool, a user input of an invoke command, identifying an application target for which the invoke command is intended, the application target presented in a presentation framework, based at least in part on the target, determining an event for the application target that is congruent with the application target and the invoke command, synthesizing the event, and applying the event to the application target. In such an example, the event alternatively or additionally may be configured for an event handler associated with the target. In such an example, the application target alternatively or additionally may be represented by a first node in a tree structure of a document object model, and the event handler alternatively or additionally may be grouped with a second node in the tree structure, the second node being higher than the first node. In such an example, synthesizing the event alternatively or additionally may include generating instructions that, when applied to the application target, cause the event to bubble up from the first node to the second node. In such an example, the event handler alternatively or additionally may be associated with one or more other application targets. In such an example, applying the event to the application target alternatively or additionally may comprise obtaining a bounding geometry associated with the application target, and applying the event at a location within the bounding geometry.

Another example provides a computing device comprising a logic machine and a storage machine holding instructions executable by the logic machine to receive, via an accessibility tool, a user input of an invoke command, identify an application target for which the invoke command is intended, the application target presented in a web-based presentation framework, based at least in part on the target, determine an event for the application target that is congruent with the application target and the invoke command, synthesize the event, and apply the event to the application target. In such an example, the event alternatively or additionally may be configured for an event handler associated with the application target. In such an example, the application target alternatively or additionally may be represented by a first node in a tree structure of a document object model, and the event handler alternatively or additionally may be grouped with a second node in the tree structure, the second node being higher than the first node.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a logic machine; and
a storage machine holding instructions executable by the logic machine to:
receive, via an accessibility tool, a user input of an invoke command;
identify an application target for which the invoke command is intended, the target presented in a presentation framework;
based at least in part on the application target, determine an event for the application target that is congruent with the application target and the invoke command;
synthesize the event; and
apply the event to the application target.

2. The computing device of claim 1, where the instructions are implemented by a web browser application.

3. The computing device of claim 1, where the application target is a control in a graphical user interface.

4. The computing device of claim 1, where the event is configured for an event handler associated with the application target.

5. The computing device of claim 4, where the application target is represented by a first node in a tree structure of a document object model, and
where the event handler is grouped with a second node in the tree structure, the second node being higher than the first node.

6. The computing device of claim 5, where the instructions executable to synthesize the event include generating instructions that, when applied to the application target, cause the event to bubble up from the first node to the second node.

7. The computing device of claim 5, where the event handler is associated with one or more other application targets.

8. The computing device of claim 4, where the instructions executable to determine the event for the application target comprise instructions executable to extract an event trigger from the event handler.

9. The computing device of claim 1, where the instructions executable to apply the event to the application target comprise instructions executable to:
obtain a bounding geometry associated with the application target; and
apply the event at a location within the bounding geometry.

10. The computing device of claim 1, where the user input is a voice input of the invoke command, and where the accessibility tool is a voice interpreter.

11. The computing device of claim 1, where the user input is a touch input of the invoke command, and where the event is a mouse event.

12. At a computing device, a method, comprising:
receiving, via an accessibility tool, a user input of an invoke command;
identifying an application target for which the invoke command is intended, the application target presented in a presentation framework;
based at least in part on the target, determining an event for the application target that is congruent with the application target and the invoke command;
synthesizing the event; and
applying the event to the application target.

13. The method of claim 12, where the event is configured for an event handler associated with the target.

14. The method of claim 13, where the application target is represented by a first node in a tree structure of a document object model, and
where the event handler is grouped with a second node in the tree structure, the second node being higher than the first node.

15. The method of claim 12, where synthesizing the event includes generating instructions that, when applied to the application target, cause the event to bubble up from the first node to the second node.

16. The method of claim 12, where the event handler is associated with one or more other application targets.

17. The method of claim 12, where applying the event to the application target comprises:
obtaining a bounding geometry associated with the application target; and
applying the event at a location within the bounding geometry.

18. A computing device, comprising:
a logic machine; and
a storage machine holding a web browser module executable by the logic machine to:
receive, via an accessibility tool, a user input of an invoke command;
identify an application target for which the invoke command is intended, the application target presented in a web-based presentation framework;
based at least in part on the target, determine an event for the application target that is congruent with the application target and the invoke command;
synthesize the event; and
apply the event to the application target.

19. The computing device of claim 18, where the event is configured for an event handler associated with the application target.

20. The computing device of claim 19, where the application target is represented by a first node in a tree structure of a document object model, and
where the event handler is grouped with a second node in the tree structure, the second node being higher than the first node.
